(19) United States
(12) Patent Application Publication
(10) Pub. No.: US 2015/0013133 A1
(43) Pub. Date: Jan. 15, 2015

(54) DOOR POSITIONING APPARATUS FOR DOOR MOUNTING DEVICE OF VEHICLE AND DOOR POSITIONING SYSTEM

(71) Applicant: Hyundai Motor Company, Seoul (KR)

(72) Inventor: Heui Bom LEE, Seoul (KR)

(73) Assignee: Hyundai Motor Company, Seoul (KR)

(21) Appl. No.: 14/105,101

(22) Filed: Dec. 12, 2013

(30) Foreign Application Priority Data
Jul. 9, 2013 (KR) 10-2013-0080402

(51) Int. Cl. B23P 19/10; B25B 11/02; B23P 19/04

(52) U.S. Cl. CPC B23P 19/10; B23P 19/04; B25B 11/02
USPC 29/281.6

(57) ABSTRACT

A door positioning apparatus for a door mounting device of a vehicle which sets the door in a door re-mounting process, is provided to the door mounting device for moving the door to a mounting position, and positions the door set on the door mounting device to the mounting position precisely may include a mounting frame movably mounted to a base frame of the door mounting device, and a pair of positioning pin which are mounted to the mounting frame movable up and down direction respectively, and provides a reference position for the door with respect to a pair of door hinge mounted to a vehicle body.

### CROSS-REFERENCE TO RELATED APPLICATION

The present application claims priority to Korean Patent Application No. 10-2013-0080402 filed on Jul. 9, 2013, the entire contents of which is incorporated herein for all purposes by this reference.

### BACKGROUND OF THE INVENTION

1. Field of the Invention

The present invention relates to a door positioning apparatus and a door positioning system. More particular, the present invention relates to a door positioning apparatus and a door positioning system which may provide a reference position for a door with respect to a door hinge mounted to a vehicle body when the door is re-mounted in a door re-mounting process.

2. Description of Related Art

In general, quality of mounting front and rear doors of a vehicle is a core factor that influences quality of internal and external appearances of the vehicle. In order to improve the quality of mounting the doors, quality enhancement of components and quality enhancement of a door mounting process are simultaneously required.

In the door mounting process of the vehicle assembling line, a door hinge is mounted to a vehicle body first using a door hinge mounting jig, and then the door is mounted on the door hinge in a state in which the door is set to the vehicle body using a door assembling jig.

When the operation of setting the door with respect to the vehicle body is completed, a level difference of the door and the sealing gap inside the door are measured, and then adjustments of the level difference and the gap are executed according to the measurements.

A vehicle body of which doors are assembled in a vehicle body line is transferred to an assembling line by a transporting line. In the assembling line, the doors are disassembled from door hinges for various elements to be assembled to the vehicle body.

The disassembled doors are transferred to post lines through separated transporting lines and hangers, and the vehicle body, of which the doors are disassembled, goes through a chassis mounting line, a final line and so on through the transporting line, and then is transferred to a door re-mounting line.

In the door re-mounting process, the doors are separated from the hangers, the doors are set on a door mounting device, the door mounting device is moved to a mounting position of the vehicle body, wire connectors and so on are assembled to the door, and then the doors are mounted to the door hinges of the vehicle body.

In the assembling line, since the doors are disassembled from door hinges, the various elements are assembled to the vehicle body, and then the doors are re-mounted to the vehicle body, a level difference of the door and the sealing gap inside the door are measured again, and adjustments of the level difference and the gap are executed again.

However, a distribution of position of the door set on the door mounting device, a distribution of position of the vehicle on the transporting line, and so on may cause inaccurate positioning of the door with respect to the vehicle body.

Thus, workers may shake doors to adjust the positions then mount the door to the vehicle body due to a distribution of position of the door on the door mounting device, a distribution of position of the door on the transporting line, a distribution of mounting position of various vehicle kinds and so on.

Thus, in a conventional art, in door re-mounting process, a lot of time is required to mount the door manually, and mounting quality is deteriorated.

Also, in the conventional art, for measuring and adjustment of the level difference of the door and the sealing gap inside the door 4-5 manpower are required generally.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a door positioning apparatus and a door positioning system which may provide a reference position for a door with respect to a door hinge mounted to a vehicle body when the door is re-mounted in a door re-mounting process.

In an aspect of the present invention, a door positioning apparatus for a door mounting device of a vehicle which sets a door in a door re-mounting process, is provided to the door mounting device for moving the door to a mounting position, and positions the door set on the door mounting device to the mounting position precisely, may include a mounting frame movably mounted to a base frame of the door mounting device, and a pair of positioning pins which are mounted to the mounting frame movable up and down direction respectively, and provides a reference position for the door with respect to a pair of door hinges mounted to a vehicle body.

The apparatus may further include a first moving unit mounted to the door mounting device for moving the mounting frame, and a second moving unit mounted to the mounting frame for the pair of positioning pins to be moved to a hinge pin of the door hinges.

The first moving unit may include a first moving unit drive motor mounted to the base frame, and an LM (Linear Motion) module mounted to the mounting frame and engaged to the first moving unit drive motor for moving the mounting frame according to the operation of the first moving unit drive motor.

The LM module may include a lead screw connected to the first moving unit drive motor, and an LM guide connected to the mounting frame, slidably engaged with the lead screw, and moving the mounting frame according to the operation of the first moving unit drive motor.

The second moving unit is mounted to the mounting frame through a mounting bracket.

The second moving unit may include pneumatic cylinders, as a pair, which are mounted to up and down portions of the mounting frame respectively, connected to the positioning pins respectively, and moves the positioning pins.

The second moving unit may include a second moving unit drive motor mounted to the mounting frame, a pinion gear connected to the second moving unit drive motor, and a pair of racks where the pinion gear is interposed therebetween, of which the positioning pins are connected thereto respectively, and the pair of racks which are engaged with the pinion gear.

The second moving unit may include a bi-directional cylinder which is mounted to the mounting frame, of which the positioning pins are connected to both ends thereof, and the bi-directional cylinder which moves the positioning pins.

The positioning pin may include a pin body of which a first end is connected to the second moving unit, and a socket which is connected to a second end of the pin body and selectively connected to the hinge pin of the door hinges.

The socket is connected to the protruded hinge pin, hingedly connecting a vehicle body side hinge bracket of the door hinges and a door side hinge bracket of the door hinges.

In another aspect of the present invention, a door positioning system may include a mounting frame which supports a door, and is movably mounted to a base frame of a door mounting device, which moves the door toward a door hinge mounted to a vehicle body, a first moving unit mounted to the door mounting device for moving the mounting frame on the base frame toward the door hinge, a positioning pin providing a reference position for the door with respect to the door hinge and a socket is formed to an end thereof, and a second moving unit engaged to the positioning pin and configured for moving the positioning pin toward the door hinge, wherein a hinge pin, hingedly connecting a vehicle body side hinge bracket of the door hinge and a door side hinge bracket of the door hinge, protrudes, wherein the mounting frame is moved toward the door hinge according to an operation of the first moving unit, and wherein the socket is connected with the hinge pin according to an operation of the second moving unit and provides the reference position for the door to be mounted.

The first moving unit may include a first moving unit drive motor mounted to the base frame, a lead screw connected to the first moving unit drive motor, and an LM (Linear Motion) guide connected to the mounting frame, engaged with the lead screw, and moving the mounting frame according to an operation of the first moving unit drive motor.

A pair of door hinges are mounted to upper and lower portions of the vehicle body respectively, wherein each of the hinge pins protrudes toward a center of the door hinges respectively, wherein the positioning pin is disposed as a pair corresponding to the hinge pins, and wherein the second moving unit may include a pair of pneumatic cylinders, which are mounted to up and down portions of the mounting frame respectively, connected to the positioning pins respectively, and move the positioning pins for the sockets to be connected with the hinge pins respectively.

A pair of door hinges are mounted to upper and lower portions of the vehicle body respectively, wherein each of the hinge pins protrudes toward a center of the door hinges respectively, wherein the positioning pin is disposed as a pair corresponding to the hinge pins, and wherein the second moving unit may include a second moving unit drive motor mounted to the mounting frame, a pinion gear connected to the second moving unit drive motor, and a pair of racks where the pinion gear is interposed therebetween, of which the positioning pins are connected thereto respectively, and the pair of racks which are engaged with the pinion gear for the sockets to be connected with the hinge pins respectively according to an operation of the second moving unit motor.

A pair of door hinges are mounted to upper and lower portions of the vehicle body respectively, wherein the each hinge pin protrudes toward a center of the door hinges respectively, wherein the positioning pin is disposed as a pair corresponding to the hinge pins, and wherein the second moving unit may include a bi-directional cylinder which is mounted to the mounting frame, of which the positioning pins are connected to both ends thereof, and the bi-directional cylinder which moves the positioning pins for the sockets to be connected with the hinge pins.

According to exemplary embodiments of the present invention, since a door setting position may be determined precisely by a mounting frame and a positioning pin before a door is closed to a vehicle body through a door mounting device in a door re-mounting process, the door may be connected to a door hinge of the vehicle body precisely.

Even though a distribution of position of the door on the door mounting device, a distribution of position of the door on the transporting line, a distribution of mounting position of various vehicle kinds and so on exist, the door may be set on a mounting position precisely.

Thus, according to exemplary embodiments of the present invention, in the door re-mounting process, manufacturing process may be simplified and working hours may be reduced, and mounting quality may be enhanced.

Also, according to exemplary embodiments of the present invention, in the door re-mounting process, measuring process for a level difference of the door and a sealing gap inside the door are simplified and time consuming for measuring may be reduced.

And cycle time and man power for the working door re-mounting process may be reduced and production cost also may be reduced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view showing a door positioning apparatus for a door mounting device of a vehicle according to an exemplary embodiment of the present invention.

FIG. 2 is a drawing showing a door hinge of which a door positioning apparatus according to an exemplary embodiment of the present invention may be applied.

FIG. 3 is a drawing showing a first moving unit which is applied to a door positioning apparatus according to an exemplary embodiment of the present invention.

FIG. 4 is a perspective view showing a second moving unit and a positioning pin which is applied to a door positioning apparatus according to an exemplary embodiment of the present invention.

FIG. 5 is a drawing showing a first modified second moving unit and a positioning pin which is applied to a door positioning apparatus according to a first modified embodiment of the present invention.

FIG. 6 is a perspective view showing a second modified second moving unit and a positioning pin which is applied to a door positioning apparatus according to a second modified embodiment of the present invention.

FIG. 7 is a drawing showing an operation of a door positioning system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

The size and thickness of each component illustrated in the drawings are arbitrarily shown for understanding and ease of description, but the present invention is not limited thereto. Thicknesses of several portions and regions are enlarged for clear expressions.

Further, in the following detailed description, names of constituents, which are in the same relationship, are divided into “the first”, “the second”, and the like, but the present invention is not limited to the order in the following description.

Throughout the specification and the claims, unless explicitly described to the contrary, the word “include” and variations such as “includes” or “including” will be understood to imply the inclusion of stated elements but not the exclusion of any other elements.

In addition, “unit”, “means”, “part”, “member”, or the like, which is described in the specification, means a unit of a comprehensive configuration that performs at least one function or operation.

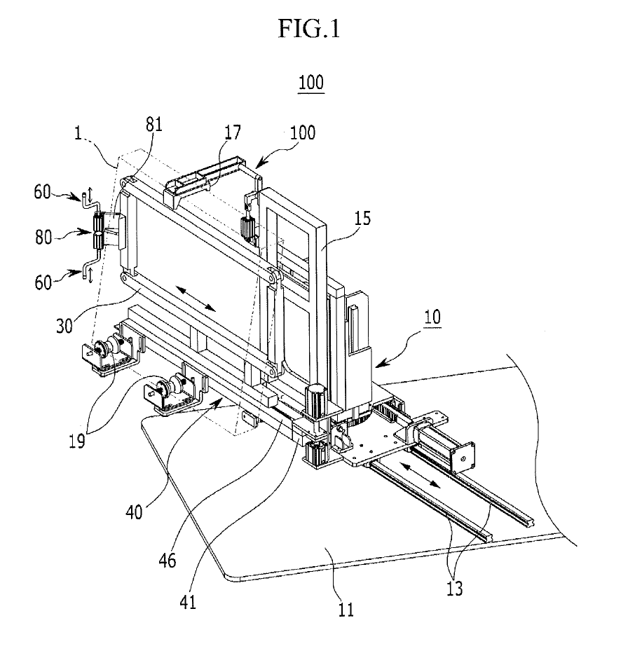

FIG. 1 is a perspective view showing a door positioning apparatus for a door mounting device of a vehicle according to an exemplary embodiment of the present invention.

Referring to FIG. 1, a door positioning apparatus 100 for a door mounting device of a vehicle according to an exemplary embodiment of the present invention may be applied to a door re-mounting process where a door 1, disassembled for assembling various elements to a vehicle body, is re-mounted.

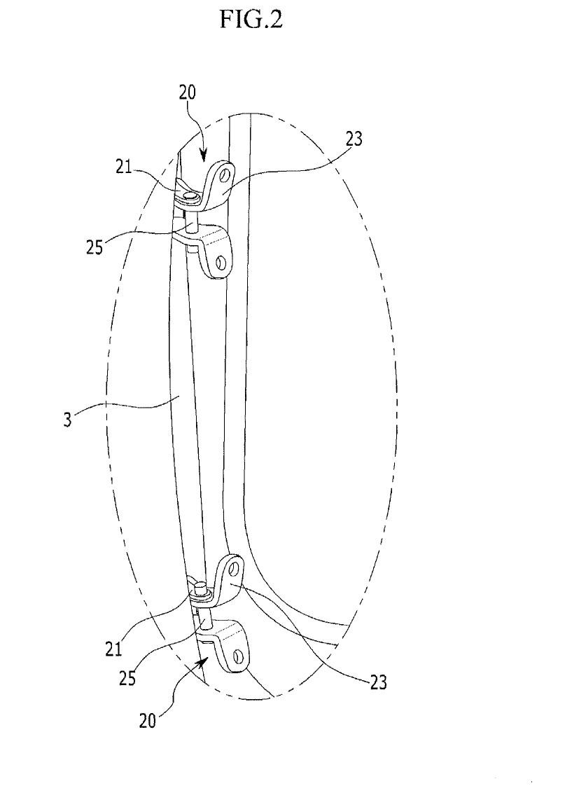

In the door re-mounting process, the door 1 is separated from a hanger, the door 1 is set on a door mounting device 10, the door mounting device 10 is moved to a mounting position of the vehicle body 3 (referring to FIG. 2), wire connectors and so on are assembled to the door 1, and then the door 1 is mounted to the door hinge 20 (referring to FIG. 2) of the vehicle body.

The door mounting device 10 supports the door 1, and moves door 1 to a door hinge 20 of the vehicle body 3. And the door mounting device 10 is disposed on a moving base 11 which is synchronized with a transporting line for moving the vehicle body 3.

The door mounting device 10 includes a base frame 15 movable along rails 13 disposed on the moving base 11 toward the vehicle body 3 on the transporting line, an upper supporting member 17 mounted to the base frame 15 for supporting the door 1 and a lower support roller 19.

The base frame 15 of the door mounting device 10 is rotatable on the rail 13, height of which is adjustable, and is tillable.

The main structures and functions of the door mounting device 10 are disclosed in KR 0798897 and KR 0892700, and thus detailed description of the door mounting device 10 will be omitted.

The door hinge 20, as shown in FIG. 2, is mounted to the vehicle body 3 in a state of the door 1 to be disassembled. The door hinge 20 may be a pair, and the door hinges 20 are mounted up and down portions of a pillar of the vehicle body 3 apart from each other.

The door hinge 20 according to an exemplary embodiment of the present invention includes a vehicle body side hinge bracket 21 of the door hinge 20, a door side hinge bracket 23 of the door hinge 20 and a hinge pin 25 hingedly connecting the vehicle body side hinge bracket 21 of the door hinge 20 and the door side hinge bracket 23 of the door hinge 20.

In this case, the hinge bracket 21 may be connected to the vehicle body 3 through a weld nut, and the hinge bracket 23 may be connected to the door 1 through a weld nut.

The hinge pin 25 applied to the upper door hinge 20 protrudes lower direction, and the hinge pin 25 applied to the lower door hinge 20 protrudes upper direction. That is, the each hinge pin 25 protrudes toward a center of the door hinges 25 respectively.

The door positioning apparatus 100 according to an exemplary embodiment of the present invention is mounted to the base frame 15 of the door mounting device 10.

The door positioning apparatus 100 according to an exemplary embodiment of the present invention may provide a reference position for the door 1 with respect to the door hinge 20 mounted to the vehicle body 3.

That is, the door positioning apparatus 100 according to an exemplary embodiment of the present invention may set the mounting position of the door 1 with respect to the door hinge 20 before the door 1 approaches the vehicle body 3 by the operation of the door mounting device 10.

The door positioning apparatus 100 according to an exemplary embodiment of the present invention may include a mounting frame 30, a first moving unit 40, a positioning pin 60 and a second moving unit 80. The positioning pin 60 may be a pair.

The mounting frame 30 is movable on base frame 15 independent from the door 1 disposed on the door mounting device 10. The mounting frame 30 may include unit frames forming a square shape, but it is not limited thereto.

At the mounting frame 30 various constituent elements may be mounted thereto. The various elements may be various brackets, blocks, plates, housing, cover and support blocks.

The accessories are referred to as mounting frame 30 in the exemplary embodiment of the present invention except for an exceptional case.

The first moving unit 40 for moving the mounting frame 30 on the base frame 15 of the door mounting device 10 toward the direction that the door 1 will move.

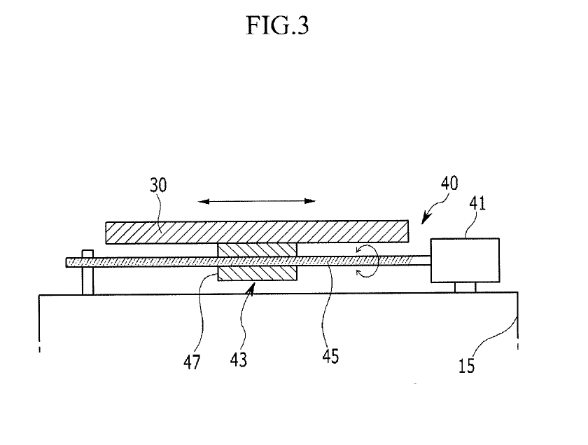

FIG. 3 is a drawing showing a first moving unit which is applied to a door positioning apparatus according to an exemplary embodiment of the present invention.

Referring to FIG. 3, the first moving unit 40 include a first moving unit drive motor 41 mounted to the base frame 15 and an LM (Liner Motion) module 43. The first moving unit drive motor 41 is fixed to the base frame 15. The LM module 43 is connected to the first moving unit drive motor 41.

The LM module 43 includes a lead screw 45 connected to the first moving unit drive motor 41 and an LM guide 47 engaged with the lead screw 45. The lead screw 45 is connected with a drive shaft of the first moving unit drive motor 41.

The LM guide 47 is engaged with the lead screw 45 and moves according to the rotation of the lead screw 45 along the guide rail 46 (referring to FIG. 1). The mounting frame 30 is fixed to the LM guide 47.

Referring to FIG. 1 and FIG. 2, a pair of positioning pins 60 provide the reference position of the door 1 with respect to the door hinges 20 mounted to the vehicle body 3. That is, the positioning pins 60 provide setting position for mounting the door 1.

The each positioning pin 60 is movable on the mounting frame 30 up and down direction. The positioning pins 60 may move up and down direction on the mounting frame 30 by the operation of the second moving unit 80.

The second moving unit 80 moves a pair of positioning pin 60 up and down direction with respect to the hinge pin 25 of the door hinge 20 and is mounted to an end portion the mounting frame 30.

The second moving unit 80 is mounted to the mounting frame 30 though a mounting bracket 81, and the second moving unit 80 may be a pair to be disposed apart from each other.

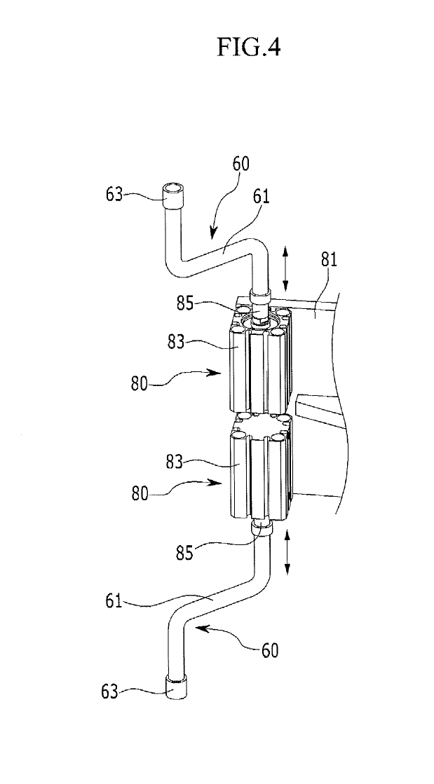

FIG. 4 is a perspective view showing a second moving unit and a positioning pin which is applied to a door positioning apparatus according to an exemplary embodiment of the present invention.

The second moving unit 80 includes a pneumatic cylinder 83 where each positioning pin 60 is connected. The each pneumatic cylinder 83 is apart from each other and is mounted to the mounting bracket 81.

The pneumatic cylinder 83 includes an operating rod 85. And the operating rod 85 of the upper pneumatic cylinder 83 moves forward and rearward to upward, and the operating rod 85 of the lower pneumatic cylinder 83 moves forward and rearward to downward.

Referring to FIG. 4, each positioning pin 60 includes a pin body 61 connected to the operating rod 85 of the pneumatic cylinder 83, and a socket 63 connected to the pin body 61.

The pin body 61 is shaped as “L”.

Referring to FIG. 2 and FIG. 4, the socket 63 connected to the pin body 61 is connectable to the hinge pin 25 of the door hinge 20.

When the positioning pin 60 moves by the operation of pneumatic cylinder 83 of the second moving unit 80, the socket 63 of the upper positioning pin 60 is coupled to the hinge pin 25 protruded downward of the upper door hinge 20, and the socket 63 of the lower positioning pin 60 is coupled to the hinge pin 25 protruded upward of the lower door hinge 20.

That is, the socket 63 of the upper positioning pin 60 is open upward and the socket 63 of the lower positioning pin 60 is open downward.

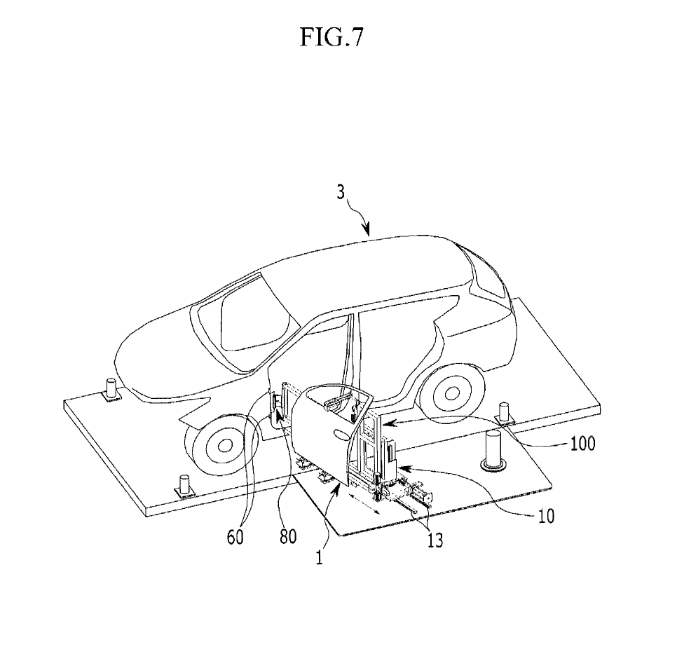

FIG. 7 is a drawing showing an operation of a door positioning system according to an exemplary embodiment of the present invention.

Operations of the door positioning apparatus 100 and the door home position system according to an exemplary embodiment of the present invention with the configuration described above will be described referring to FIG. 1 to FIG. 7.

The door 1 is separated from a hanger, and then the door 1 is set on a door mounting device 10 using a loading jig.

In this case, the door mounting device 10 is movable along the rails 13 disposed on the moving base 11 on the transporting line. In this case, the upper and the lower portion of the door 1 is supported by the upper supporting member 17 and the lower support roller 19 at door mounting device 10.

The base frame 15 of the door mounting device 10 supporting the door 1 is rotatable on the rail 13, height of which is adjustable, and is tillable for being adapted to the door hinge 20 of the vehicle body 3.

At this moment, the mounting frame 30 is relatively far away from the vehicle body 3 by the operation of the first moving unit 40, and the positioning pins 60 are in backward sate by the operations of the pneumatic cylinders 83 of the second moving unit 80.

That is, the positioning pin 60 positioned upward is in backward sate to downward by the operating rod 85 of the pneumatic cylinder 83, and the positioning pin 60 positioned downward is in backward sate to upward by the operating rod 85 of the pneumatic cylinder 83.

At this state, the mounting frame 30 is moved toward the vehicle body 3 on the base frame 15 by the operation of the first moving unit 40.

In this case, the first moving unit drive motor 41 of the first moving unit 40 is operated and then the lead screw 45 connected to the operation of first moving unit drive motor 41 rotates. Then the LM guide 47 engaged with the lead screw 45 moves along the lead screw 45. Thus, the mounting frame 30 connected to the LM guide 47 moves toward the vehicle body 3.

Thus, an end of the mounting frame 30 is positioned near a pillar of the vehicle body 3, and the positioning pin 60 is positioned corresponding to the door hinge 20 of the vehicle body 3.

Then the pneumatic cylinder 83 of the second moving unit 80 is operated to move the positioning pin 60 forward.

That is, the positioning pin 60 positioned upward moves upward by the operating rod 85 of the pneumatic cylinder 83, and the positioning pin 60 positioned downward moves downward by the operating rod 85 of the pneumatic cylinder 83.

Then each socket 63 of the positioning pin 60 matches with the hinge pin 25 of the door hinge 20. That is, the socket 63 of the upper positioning pin 60 is connected with the hinge pin 25 protruded downward and the socket 63 of the lower positioning pin 60 is connected with the hinge pin 25 protruded upward.

Since the mounting frame 30 moves toward the vehicle body 3 then the sockets 63 of the positioning pins 60 are connected with the hinge pins 25 of the door hinge 20, thus the setting position of the door 1 with respect to the door hinge 20 may be set on precisely.

After setting on the position of the door 1 with respect to the door hinge 20, the door mounting device 10 is moved toward the vehicle body 3 along the rail 13 on the moving base 11. Then, the door 1 supported by the base frame 15 of the door mounting device 10 moves toward the vehicle body 3.

In the state of setting the position of the door 1 with respect to the door hinge 20 using the mounting frame 30 and the positioning pins 60, the door 1 moves toward the vehicle body 3. Thus, door hinge mounting holes of the door 1 may be positioned corresponding to the door hinge 20 of the vehicle body 3.

After positioning the door hinge mounting holes of the door 1 corresponding to the door hinge 20 of the vehicle body 3, fastening units fasten the door side hinge bracket 23 of the door hinge 20 and the door hinge mounting holes of the door 1 so as that the door 1 is mounted to the vehicle body 3.

If there is a distribution of position of the door 1 set on the door mounting device 10 and a distribution of position of the vehicle body 3 set on the transporting line, the socket 63 of the positioning pin 60 may not match with the hinge pin 25 of the door hinge 20.

Further, when the setting positions of the doors 1 are various with respect to the vehicle body 3 according to various vehicle models or various manufacturing lines, the socket 63 of the positioning pin 60 may not match with the hinge pin 25 of the door hinge 20.

In this case, the positioning pins 60 are returned to the original positions by the operation of the second moving unit 80, and then position, rotation angle and height of the base frame 15 of the door mounting device 10 is adjusted using a tilting unit, a rotation unit and a height adjusting unit. So that the positions of the mounting frame 30 and the door 1 are adjusted.

And then the operations described above are repeated. That is, the mounting frame 30 is moved toward the vehicle body 3, the positioning pins 60 move upward and downward to match the sockets 63 with hinge pins 25 respectively. And thus, the door 1 setting position with respect to the door hinge 20 is provided.

According to exemplary embodiments of the present invention, the door setting position may be determined precisely by the mounting frame 30 and the positioning pins 60 before the door 1 moved toward the vehicle body 3 through the door mounting device 10 in the door re-mounting process.

Thus, in the door re-mounting process, the door 1 is positioned with respect to the door hinge 20 then the door 1 is mounted to the door hinge 20 of the vehicle body 3 precisely.

Even though a distribution of position of the door 1 on the door mounting device 10, a distribution of position of the door 1 on the transporting line, a distribution of mounting position of various vehicle kinds and so on exist, the door 1 may be set on a mounting position precisely.

Thus, according to exemplary embodiments of the present invention, in the door re-mounting process, manufacturing process may be simplified and working hours may be reduced, and mounting quality may be enhanced.

Also, according to exemplary embodiments of the present invention, in the door re-mounting process, measuring process for a level difference of the door 1 and a sealing gap inside the door 1 are simplified and time consuming for measuring may be reduced.

And cycle time and man power for the working door re-mounting process may be reduced and production cost also may be reduced.

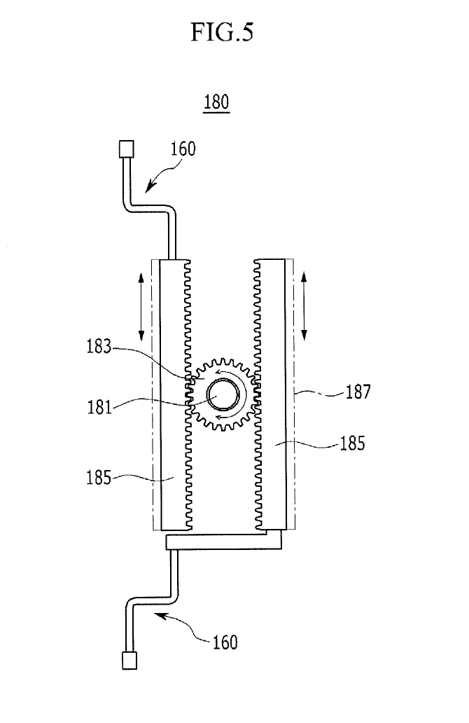

FIG. 5 is a drawing showing a first modified second moving unit and a positioning pin which is applied to a door positioning apparatus according to a first modified embodiment of the present invention.

Referring to FIG. 5, in the first modified embodiment of the present invention, a second moving unit 180 is applied for moving up and down a pair of positioning pins 160.

In the first modified embodiment of the present invention, the second moving unit 180 includes a second moving unit drive motor 181 mounted to the mounting frame 30 (referring to FIG. 1), a pinion gear 183 connected to the second moving unit drive motor 181, and a pair of racks 185 parallel to each other interposing the pinion gear 183.

The pair of racks 185 are disposed parallel within a case 187 mounted to the mounting frame 30 and engaged with the pinion gear 183.

One of the positioning pins 160 is fixed to an upper portion of one of the racks 185 and the other positioning pin 160 is fixed to a lower portion of the other rack 185 respectively. A drive shaft of the second moving unit drive motor 181 is connected with the pinion gear 183 through the case 187.

If the second moving unit drive motor 181 is operated to rotate the pinion gear 183, the pair of racks 185 move up and down respectively to move the positioning pins 160 move up and down respectively.

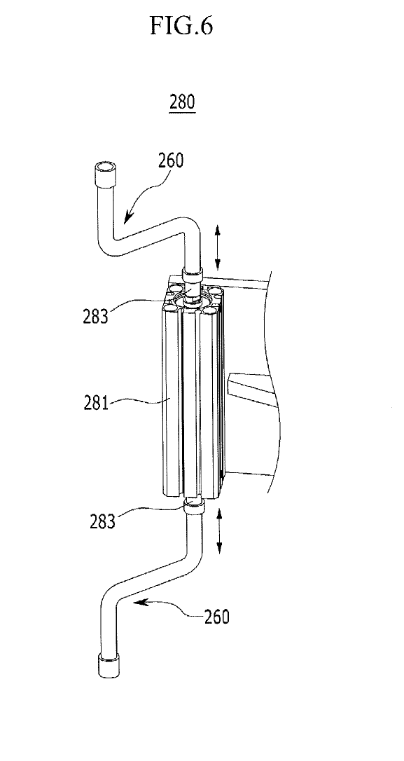

FIG. 6 is a perspective view showing a second modified second moving unit and a positioning pin which is applied to a door positioning apparatus according to a second modified embodiment of the present invention.

Referring to FIG. 6, in the second modified embodiment of the present invention, a second moving unit 280 is applied for moving up and down a pair of positioning pins 260 using a bi-directional cylinder 281.

In the second modified embodiment of the present invention, operating rods 283 are moved by the operation of the bi-directional cylinder 281, and the bi-directional cylinder 281 is mounted to the mounting frame 30 (referring to FIG. 1).

The positioning pins 260 are connected to the operating rods 283 respectively.

If the operating rods 283 are moved forward and rearward by the operation of the bi-directional cylinder 281, the positioning pins 260 are moved up and down through the operating rods 283.

The bi-directional cylinder 281 may be a bi-directional pneumatic cylinder which is known to a person skilled in the art, and thus detailed description will be omitted.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. A door positioning apparatus for a door mounting device of a vehicle which sets a door in a door re-mounting process, is provided to the door mounting device for moving the door to a mounting position, and positions the door set on the door mounting device to the mounting position precisely, the door positioning apparatus comprising:
a mounting frame movably mounted to a base frame of the door mounting device; and
a pair of positioning pins which are mounted to the mounting frame movable up and down direction respectively, and provides a reference position for the door with respect to a pair of door hinges mounted to a vehicle body.

2. The apparatus of claim 1, wherein the apparatus further comprises:
a first moving unit mounted to the door mounting device for moving the mounting frame; and
a second moving unit mounted to the mounting frame for the pair of positioning pins to be moved to a hinge pin of the door hinges.

3. The apparatus of claim 2, wherein the first moving unit comprises:
a first moving unit drive motor mounted to the base frame; and
an LM (Linear Motion) module mounted to the mounting frame and engaged to the first moving unit drive motor for moving the mounting frame according to the operation of the first moving unit drive motor.

4. The apparatus of claim 3, wherein the LM module comprises:
a lead screw connected to the first moving unit drive motor; and
an LM guide connected to the mounting frame, slidably engaged with the lead screw, and moving the mounting frame according to the operation of the first moving unit drive motor.

5. The apparatus of claim 2, wherein the second moving unit is mounted to the mounting frame through a mounting bracket.

6. The apparatus of claim 2, wherein the second moving unit comprises:
pneumatic cylinders, as a pair, which are mounted to up and down portions of the mounting frame respectively, connected to the positioning pins respectively, and moves the positioning pins.

7. The apparatus of claim 2, wherein the second moving unit comprises:
a second moving unit drive motor mounted to the mounting frame;
a pinion gear connected to the second moving unit drive motor; and
a pair of racks where the pinion gear is interposed therebetween, of which the positioning pins are connected thereto respectively, and the pair of racks which are engaged with the pinion gear.

8. The apparatus of claim 2, wherein the second moving unit comprises:
a bi-directional cylinder which is mounted to the mounting frame, of which the positioning pins are connected to both ends thereof, and the bi-directional cylinder which moves the positioning pins.

9. The apparatus of claim 2, wherein the positioning pin comprises:
a pin body of which a first end is connected to the second moving unit; and
a socket which is connected to a second end of the pin body and selectively connected to the hinge pin of the door hinges.

10. The apparatus of claim 9, wherein the socket is connected to the protruded hinge pin, hingedly connecting a vehicle body side hinge bracket of the door hinges and a door side hinge bracket of the door hinges.

11. A door positioning system comprising:
a mounting frame which supports a door, and is movably mounted to a base frame of a door mounting device, which moves the door toward a door hinge mounted to a vehicle body;
a first moving unit mounted to the door mounting device for moving the mounting frame on the base frame toward the door hinge;
a positioning pin providing a reference position for the door with respect to the door hinge and a socket is formed to an end thereof; and
a second moving unit engaged to the positioning pin and configured for moving the positioning pin toward the door hinge,
wherein a hinge pin, hingedly connecting a vehicle body side hinge bracket of the door hinge and a door side hinge bracket of the door hinge, protrudes,
wherein the mounting frame is moved toward the door hinge according to an operation of the first moving unit, and
wherein the socket is connected with the hinge pin according to an operation of the second moving unit and provides the reference position for the door to be mounted.

12. The system of claim 11, wherein the first moving unit comprises:
a first moving unit drive motor mounted to the base frame;
a lead screw connected to the first moving unit drive motor; and
an LM (Linear Motion) guide connected to the mounting frame, engaged with the lead screw, and moving the mounting frame according to an operation of the first moving unit drive motor.

13. The system of claim 11,
wherein a pair of door hinges are mounted to upper and lower portions of the vehicle body respectively,
wherein each of the hinge pins protrudes toward a center of the door hinges respectively,
wherein the positioning pin is disposed as a pair corresponding to the hinge pins, and
wherein the second moving unit comprises a pair of pneumatic cylinders, which are mounted to up and down portions of the mounting frame respectively, connected to the positioning pins respectively, and move the positioning pins for the sockets to be connected with the hinge pins respectively.

14. The system of claim 11,
wherein a pair of door hinges are mounted to upper and lower portions of the vehicle body respectively,
wherein each of the hinge pins protrudes toward a center of the door hinges respectively,
wherein the positioning pin is disposed as a pair corresponding to the hinge pins, and
wherein the second moving unit comprises:
a second moving unit drive motor mounted to the mounting frame;
a pinion gear connected to the second moving unit drive motor; and
a pair of racks where the pinion gear is interposed therebetween, of which the positioning pins are connected thereto respectively, and the pair of racks which are engaged with the pinion gear for the sockets to be connected with the hinge pins respectively according to an operation of the second moving unit motor.

15. The system of claim 11,
wherein a pair of door hinges are mounted to upper and lower portions of the vehicle body respectively,
wherein the each hinge pin protrudes toward a center of the door hinges respectively,
wherein the positioning pin is disposed as a pair corresponding to the hinge pins, and
wherein the second moving unit comprises:
a bi-directional cylinder which is mounted to the mounting frame, of which the positioning pins are connected to both ends thereof, and the bi-directional cylinder which moves the positioning pins for the sockets to be connected with the hinge pins.
